(19) United States
(12) Patent Application Publication
(10) Pub. No.: US 2021/0364974 A1
(43) Pub. Date: Nov. 25, 2021

(54) IMAGE READING APPARATUS AND IMAGE FORMING APPARATUS

(71) Applicant: Konica Minolta, Inc., Tokyo (JP)

(72) Inventor: Daiki HIRATA, Aichi (JP)

(21) Appl. No.: 17/324,644

(22) Filed: May 19, 2021

(30) Foreign Application Priority Data
May 20, 2020 (JP) 2020-088111

(51) Int. Cl. G03G 15/00

(52) U.S. Cl. CPC G03G 15/6567; G03G 2215/00721; G03G 15/5062; G03G 15/607

(57) ABSTRACT

An image reading apparatus includes a detector that detects positions of a plurality of images for detection formed in different positions in a main scanning direction of a recording medium by an image forming apparatus, and the detector has a detection range equal to or shorter than a width of the recording medium in the main scanning direction. An image forming apparatus includes an image former that forms an image on a recording medium, and the image reading apparatus. The image reading apparatus performs detection for the positions of the plurality of images for detection formed on the recording medium by the image former.

### CROSS REFERENCE TO RELATED APPLICATIONS

The present invention claims priority under 35 U.S.C. § 119 to Japanese Patent Application No. 2020-88111, filed on May 20, 2020, which the entire content of which is incorporated herein by reference.

### BACKGROUND

### Technological Field

The present invention relates to an image reading apparatus and an image forming apparatus.

### Description of Related Art

Severe standards or conditions for image alignment on sheets are set, in some cases, for image forming apparatuses that form images on sheets as recording media. The image alignment has been performed in the following manner. Detection marks are formed for the image alignment on ends or four corners of a sheet, and the detection marks are read by an image reading apparatus such as a Contact Image Sensor (CIS). The image forming position is then corrected by changing image forming conditions (e.g., image forming timings) according to the distance between the detection marks read by the image reading apparatus and the ends of the sheet (See, for example, Japanese Patent Application Laid-Open No. 2000-305324).

In the image alignment method described above, however, the larger the sheet size is in a main scanning direction orthogonal to a sheet conveyance direction, the wider the image reading apparatus is in the main scanning direction. That is, the image reading apparatus needs to be wider in the main scanning direction in order to read the detection marks formed on the ends or the four corners of large sheets. This causes a problem where the image reading apparatus increases in its size and the cost of the apparatus increases accordingly. To prevent the increase in size of the image reading apparatus, a method can be considered of respectively providing relatively small image reading apparatuses on both sides of the main scanning direction of the sheet. This method, however, increases the number of the image reading apparatuses and causes the problem of increasing the apparatus cost.

### SUMMARY

An object of the present invention is to provide an image reading apparatus and an image forming apparatus each capable of reducing apparatus cost.

To achieve at least one of the above-mentioned objects, according to an aspect of the present invention, an image reading apparatus reflecting one aspect of the present invention is an apparatus, including: a detector that detects positions of a plurality of images for detection formed in different positions in a main scanning direction of a recording medium by an image forming apparatus, wherein the detector has a detection range equal to or shorter than a width of the recording medium in the main scanning direction.

To achieve at least one of the above-mentioned objects, according to an aspect of the present invention, an image forming apparatus reflecting one aspect of the present invention is an apparatus, including: an image former that forms an image on a recording medium; and the image reading apparatus, wherein the image reading apparatus performs detection for the positions of the plurality of images for detection formed on the recording medium by the image former.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically illustrating an entire configuration of an image forming apparatus according to an embodiment of the present invention;

FIG. 2 is a block diagram illustrating main sections of a control system of the image forming apparatus according to the embodiment of the present invention;

FIG. 3A is a diagram illustrating an image reading section, seen from a side of a sheet;

FIG. 3B is a diagram illustrating the image reading section, seen from above the sheet; and

FIG. 4 is a flowchart describing an image alignment method using the image reading section.

### DETAILED DESCRIPTION OF EMBODIMENTS

Hereinafter, one or more embodiments of the present invention will be described with reference to the drawings. However, the scope of the invention is not limited to the disclosed embodiments.

An embodiment of the present invention will be described in detail below with reference to the accompanying drawings.

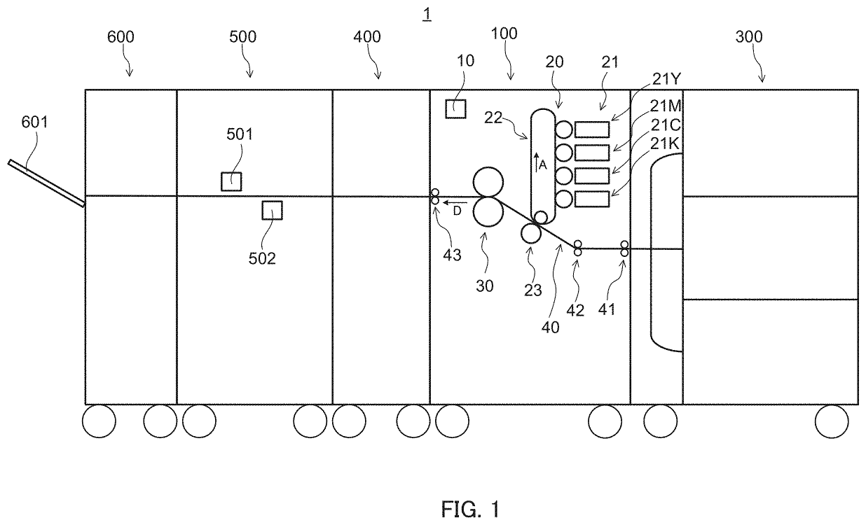

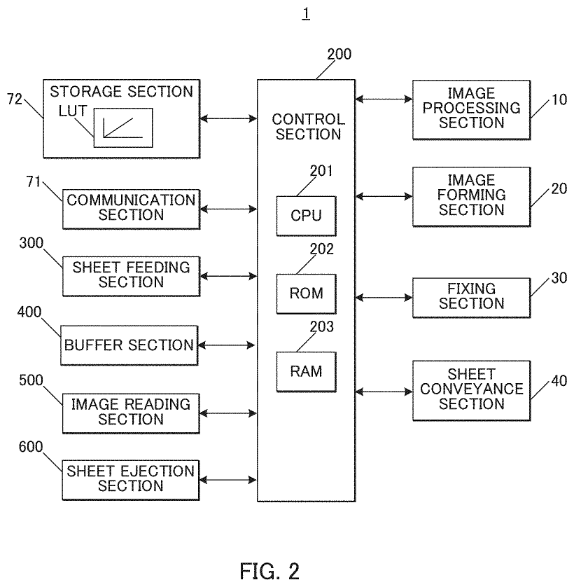

FIG. 1 is a diagram schematically illustrating an entire configuration of image forming apparatus 1 according to the present embodiment. FIG. 2 is a block diagram illustrating main sections of a control system of image forming apparatus 1 according to the present embodiment.

Image forming apparatus 1 is an apparatus capable of forming images on sheets (recording media). Image forming apparatus 1 includes image forming apparatus body 100, sheet feeding section 300, buffer section 400, image reading section 500, and sheet ejection section 600, for example, as illustrated in FIG. 1.

Image forming apparatus body 100 is a color image forming apparatus with an intermediate transfer system utilizing electrophotographic process technology. That is, image forming apparatus body 100 forms an image as follows. Image forming apparatus body 100 primarily transfers toner images of respective colors C, M, Y, and K formed on photoconductors onto an intermediate transfer member, superimposes the toner images of the four colors on one another on the intermediate transfer member, and then secondarily transfers the resultant image to a sheet. Note that C, M, Y, and K respectively represent cyan (C), magenta (M), yellow (Y), and black (K).

Image forming apparatus body 100 employs a tandem system. In the tandem system, the photoconductors respectively corresponding to the four colors of C, M, Y, and K are placed in series in a travelling direction of the intermediate transfer member, and the toner images of the four colors are sequentially transferred onto the intermediate transfer member in one cycle.

Image forming apparatus 1 includes image processing section 10, image forming section 20, fixing section 30, sheet conveyance section 40, communication section 71, storage section 72, control section 200 (hardware processor), sheet feeding section 300, buffer section 400, image reading section 500, and sheet ejection section 600, for example, as illustrated in FIG. 2.

Control section 200 includes, for example, central processing unit (CPU) 201, read only memory (ROM) 202, and random access memory (RAM) 203. CPU 201 reads a program according to processing contents from ROM 202, develops the program in RAM 203, and integrally controls an operation of each block of image forming apparatus 1 in cooperation with the developed program. At this time, control section 200 refers to various data, such as a look up table (LUT), stored in storage section 72. Storage section 72 is composed of, for example, a non-volatile semiconductor memory (so-called flash memory) or a hard disk drive.

Control section 200 transmits and receives various data to and from an external apparatus (e.g., a personal computer) connected to a communication network such as a local area network (LAN) or a wide area network (WAN), through communication section 71. Control section 200 receives, for example, image data transmitted from the external apparatus, and forms an image on a sheet based on the image data (input image data). Communication section 71 is composed of, for example, a communication control card such as a LAN card.

Control section 200 is connected to each of an operation display section (not illustrated), image processing section 10, image forming section 20, fixing section 30, sheet conveyance section 40, communication section 71, storage section 72, sheet feeding section 300, buffer section 400, image reading section 500, and sheet ejection section 600. These connected sections execute predetermined processing based on the control of control section 200.

The operation display section includes, for example, a liquid crystal display (LCD) with a touch screen, and functions as a display section and an operation section. The display section displays, for example, various operation screens, image conditions, operation statuses of functions in accordance with display control signals inputted from control section 200. The operation section includes various operation keys such as numeric keys and a start key, receives various operations inputted by a user, and outputs operation signals to control section 200.

Image processing section 10 includes, for example, a circuit that performs image processing according to initial settings or user settings on the input image data. Image forming section 20 is controlled based on the image data subjected to the image processing.

Image forming section 20 includes, for example, image forming units 21 (21Y, 21M, 21C, and 21K), intermediate transfer unit 22, and secondary transfer unit 23. Image forming unit 21Y forms images with a colored toner of a Y component based on the image data from image processing section 10. Likewise, image forming units 21M, 21C, and 21K form images with colored toners of an M component, a C component, and a K component respectively.

Image forming units 21Y, 21M, 21C, and 21K have similar configurations to each other. To be more specific, image forming units 21Y, 21M, 21C, and 21K each include an exposing device, a developing device, a photoconductor drum, a charging device, and a drum cleaning device, for example. Known technologies can be employed for the exposing device, the developing device, the photoconductor drum, the charging device, and the drum cleaning device, and the description thereof is thus omitted.

Intermediate transfer unit 22 includes an intermediate transfer belt and the like. The intermediate transfer belt is stretched around a plurality of support rollers in a loop form, and travels in a direction of arrow A. The support rollers include rollers such as a back-up roller, a primary transfer roller, and a driving roller, although these rollers are not illustrated. The intermediate transfer belt is in pressure contact with the photoconductor drums, and this allows transferring the toner images from the photoconductor drums onto the intermediate transfer belt.

Note that intermediate transfer unit 22 may be configured with a belt cleaning device including, for example, a plate belt cleaning blade that is in sliding contact with the surface of the intermediate transfer belt. The belt cleaning device removes remaining toner on the surface of the intermediate transfer belt after the secondary transfer.

Secondary transfer unit 23 includes a secondary transfer roller and the like. The secondary transfer roller is in pressure contact with the intermediate transfer belt. This allows forming a secondary transfer nip between the intermediate transfer belt and the secondary transfer roller.

When a sheet is conveyed to the secondary transfer nip, toner images of the four colors carried by the intermediate transfer belt are collectively transferred onto the sheet in secondary transfer unit 23. The sheet with the transferred toner images is conveyed toward fixing section 30.

Note that, as secondary transfer unit 23, the secondary transfer unit including a secondary transfer roller may be replaced with a secondary transfer unit including a secondary transfer belt stretched around a plurality of support rollers.

Fixing section 30 includes a fixing roller and a pressure roller, for example. The fixing roller is heated to a predetermined fixing temperature, and the pressure roller forms a fixing nip that holds and conveys a sheet with the fixing roller. Fixing section 30 fixes the toner images on the sheet by heating and pressing the conveyed sheet with secondary-transferred toner images at the fixing nip.

Sheet conveyance section 40 includes, for example, sheet feeding conveyance section 41, conveyance path section 42, and sheet ejection conveyance section 43. Sheet feeding conveyance section 41, conveyance path section 42, and sheet ejection conveyance section 43 are composed of a plurality of conveyance rollers and a driving motor to rotate the rollers, for example. Sheet feeding conveyance section 41 conveys a sheet fed out from sheet feeding section 300 to conveyance path section 42. Conveyance path section 42 conveys the sheet to image forming section 20, and an image is formed in image forming section 20. The sheet is subjected to fixing processing in fixing section 30, and then sheet ejection conveyance section 43 conveys the sheet to buffer section 400.

Sheet feeding section 300 is placed on the upstream side of image forming apparatus body 100 in sheet conveyance direction D, which is a direction of conveying sheets, and is connected to image forming apparatus body 100. Sheet feeding section 300 includes a plurality of sheet feeding trays, and the sheet feeding trays store sheets (e.g., standard sheets and special sheets), for each preset type, identified according to the basis weight and size, for example. Sheet feeding section 300 feeds out and provides a sheet to sheet feeding conveyance section 41 of image forming apparatus body 100 based on the instruction of image forming apparatus body 100.

Buffer section 400 is placed on the downstream side of image forming apparatus body 100 in sheet conveyance direction D, and is connected to image forming apparatus body 100. Buffer section 400 is an adjusting device that is provided between image forming apparatus body 100 and image reading section 500, and absorbs a speed difference between a sheet conveyance speed in image forming apparatus body 100 and a sheet conveyance speed in image reading section 500. Note that a similar adjusting device may be provided between sheet feeding section 300 and image forming apparatus body 100. Buffer section 400 is not an essential component. Image reading section 500 may be directly connected to image forming apparatus body 100 without buffer section 400.

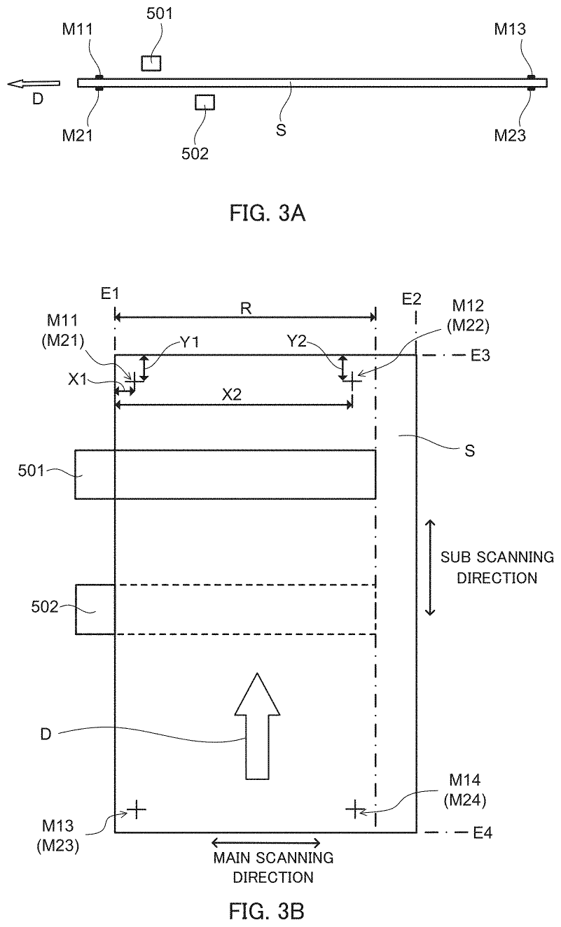

Image reading section 500 is placed on the downstream side of buffer section 400 in sheet conveyance direction D, and is connected to buffer section 400. Image reading section 500 includes detection sections 501 and 502 that detect positions of a plurality of images for detection (see FIG. 3A and FIG. 3B) formed on a sheet by image forming apparatus body 100. Detection section 501 (the first detection section) and detection section 502 (the second detection section) are placed so that detection section 501 reads images for detection on a front surface of a sheet being conveyed, and detection section 502 reads images for detection on a back surface of the sheet. Note that detection sections 501 and 502 will be described later in detail with reference to FIG. 3A and FIG. 3B. Image reading section 500 is not limited to be used for image alignment with images for detection, and is also used for inspection for defects of formed images and various calibrations.

Sheet ejection section 600 is placed on the downstream side of image reading section 500 in sheet conveyance direction D, and is connected to image reading section 500. Sheet ejection section 600 ejects the sheet conveyed from image reading section 500 outside the apparatus, and places the sheet on sheet ejection tray 601.

In image forming apparatus 1, image forming apparatus body 100 aligns images by changing image forming conditions and correcting image forming positions. The image forming conditions are changed according to the distance between the ends of the sheet and the positions of the images for detection read by detection sections 501 and 502.

Incidentally, a conventional image reading apparatus needs to be wider in a main scanning direction as the sheet size is larger in the main scanning direction. That is, the image reading apparatus needs to be wider in the main scanning direction in order to read images for detection formed on the ends or the four corners of large sheets. This causes a problem where the image reading apparatus increases in its size and the cost of the apparatus increases accordingly. To prevent the increase in size of the image reading apparatus, a method can be considered of respectively providing relatively small image reading apparatuses on both sides of the main scanning direction of the sheet. This method, however, increases the number of the image reading apparatuses and causes the problem of increasing the apparatus cost.

In the present embodiment, image reading section 500 of image forming apparatus 1 includes detection sections 501 and 502 that detect positions of a plurality of images for detection formed in different positions in the main scanning direction of sheets by image forming apparatus body 100. Detection sections 501 and 502 have a detection range equal to or shorter than the sheet width in the main scanning direction.

Detection sections 501 and 502 will be described in detail with reference to FIG. 3A and FIG. 3B. Sheet S is conveyed in sheet conveyance direction D (a sub scanning direction), and detection section 501 is placed on the upper side of sheet S so as to read images for detection M11 to M14 on a front surface of sheet S. Detection section 502 is placed on the lower side of sheet S so as to read images for detection M21 to M24 on a back surface of sheet S. In the present embodiment, detection section 501 is placed on the downstream side of detection section 502 in sheet conveyance direction D, and detection sections 501 and 502 are placed striding across one end section E1 of sheet S in the main scanning direction.

The width of detection sections 501 and 502 may be equal to or shorter than the width of sheet S in the main scanning direction. In a case where image forming apparatus 1 can convey sheets in a plurality of sizes, the width of detection sections 501 and 502 may be equal to or shorter than the width of largest sheet S available for image forming apparatus 1 in the main scanning direction.

Detection sections 501 and 502 fail to read the whole width of largest sheet S available for image forming apparatus 1, for example. Thus, images for detection M11 to M14, and M21 to M24 to be detected by detection sections 501 and 502 are formed not in the four corners of sheet S but within detection range R of sheet S.

For example, images for detection M11 and M13 are formed on the side of one end section E1 of sheet S, whereas images for detection M12 and M14 are formed away from the other side of end section E2 of sheet S and within detection range R. Images for detection M21 to M24 are formed in the same manner on the back surface of sheet S. Note that images for detection M11 to M14, and M21 to M24 are not limited to be formed in a cross shape as illustrated in the present embodiment as long as the positions are detectable.

In the present embodiment, four images for detection M11 to M14 are formed on the front surface of sheet S, and four images for detection M21 to M24 are formed on the back surface of sheet S for image alignment, but the images for detection only need to be formed on either the front surface or the back surface of sheet S. In addition, the images for detection only need to be formed at three points or more on either the front surface or the back surface of sheet S so as to be in different positions in at least one of the main scanning direction and the sub scanning direction. By way of example, two images for detection among three are placed on the same line in the main scanning direction. Alternatively, two images for detection among three are placed on the same line in sheet conveyance direction D.

As described above, the width of detection sections 501 and 502 is equal to or shorter than the width of sheet S in the main scanning direction, and images for detection M11 to M14, and M21 to M24 are formed within detection range R of sheet S in the main scanning direction, in the present embodiment. This allows shortening the width of detection sections 501 and 502 compared with a conventional apparatus disclosed in the above-mentioned Japanese Patent Application Laid-Open No. 2000-305324, thereby reducing the apparatus cost as well as reducing the size of detection sections 501 and 502.

CISs, charge-coupled devices (CCDs), or cameras employing an optical system can be used as such detection sections 501 and 502.

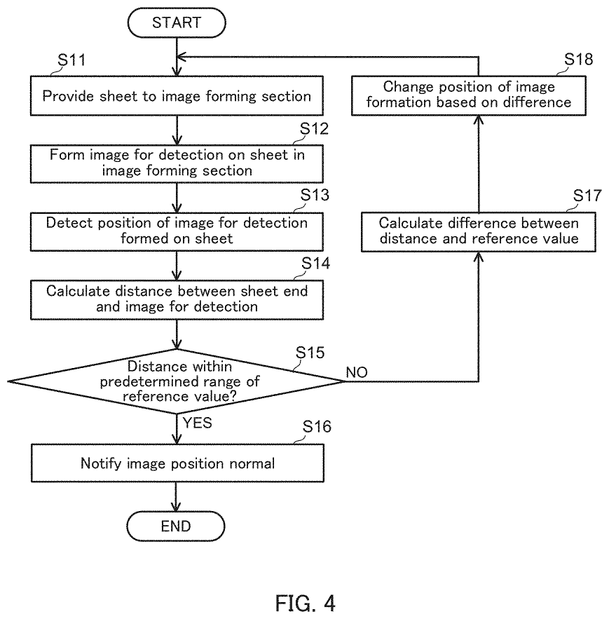

Next, a description will be given of an image alignment method using image reading section 500 including detection sections 501 and 502 described above, with reference to FIG. 4 as well as FIG. 3B. FIG. 4 is a flowchart describing the image alignment method using image reading section 500.

(Step S11)

Control section 200 controls sheet feeding section 300, and provides sheet S to image forming section 20 of image forming apparatus body 100.

(Step S12)

Control section 200 controls image forming section 20, and forms images for detection M11 to M14 and M21 to M24 on provided sheet S. At this time, image forming section 20 forms images for detection M11 to M14 and M21 to M24 within detection range R of sheet S as described above.

(Step S13)

Control section 200 controls image reading section 500, and detects the positions of end sections E1 and E3 of sheet S conveyed to image reading section 500 via fixing section 30 and buffer section 40 as well as detecting the positions of images for detection M11 to M14 and M21 to M24 on sheet S. End section E3 is an end section on the downstream side in sheet conveyance direction D.

Detection sections 501 and 502 of image reading section 500 detects the positions of end sections E1 and E3 and images for detection M11 to M14 and M21 to M24 by, for example, detecting a variation in the amount of light reflected by sheet S. The amount of reflected light varies for end sections E1 and E3 depending on the presence or absence of sheet S, and the amount of reflected light varies for images for detection M11 to M14 and M21 to M24 depending on the presence or absence of such images. Detection sections 501 and 502 can thus detect the positions of end sections E1 and E3 and images for detection M11 to M14 and M21 to M24 by detecting the variation in the amount of such reflected light.

(Step S14)

Control section (calculation section) 200 calculates distances between end sections E1 and E3 of sheet S and images for detection M11 to M14 and M21 to M24 on sheet S.

A description is given here of the calculation of the distances between end sections E1 and E3 of sheet S and images for detection M11 to M14 and M21 to M24 on sheet S, with reference to FIG. 3B.

Detection section 501 detects the positions of end section E1 of sheet S and image for detection M11 on sheet S, and control section 200 calculates distance X1 between end section E1 of sheet S and image for detection M11 on sheet S in the main scanning direction of sheet S. Detection section 501 also detects the positions of end section E1 of sheet S and image for detection M12 on sheet S, and control section 200 calculates distance X2 between end section E1 of sheet S and image for detection M12 on sheet S in the main scanning direction of sheet S. Control section 200 calculates distances X1 and X2 to images for detection M11 and M12 with end section E1 as a reference in the main scanning direction of sheet S in this manner. The same applies to images for detection M13 and M14, and the same also applies to images for detection M21 to M24 to be detected by detection section 502.

In addition, detection section 501 detects the positions of end section E3 (the end section on the downstream side in sheet conveyance direction D) of sheet S and image for detection M11 on sheet S, and control section 200 calculates distance Y1 between end section E3 of sheet S and image for detection M11 on sheet S in sheet conveyance direction D (the sub scanning direction). Detection section 501 also detects the positions of end section E3 of sheet S and image for detection M12 on sheet S, and control section 200 calculates distance Y2 between end section E3 of sheet S and image for detection M12 on sheet S in sheet conveyance direction D. Control section 200 calculates distances Y1 and Y2 to images for detection M11 and M12 with end section E3 as a reference in sheet conveyance direction D in this manner. The same applies to images for detection M13 and M14, and the same also applies to images for detection M21 to M24 to be detected by detection section 502. Note that, in cases of images for detection M13, M14, M23, and M24, distances to the respective images for detection may be calculated with end section E4 (an end section on the upstream side in sheet conveyance direction D) of sheet S as a reference.

(Step S15)

Control section 200 confirms whether the calculated distances (e.g., X1, X2, Y1, and Y2) are within predetermined ranges of reference values specified in advance. When the calculated distances are within the predetermined ranges (YES in S15), the processing proceeds to step S16. When the calculated distances are not within the predetermined ranges (NO in S15), the processing proceeds to step S17. The reference values are respectively specified for images for detection M11 to M14 and M21 to M24. For example, the center position of image for detection M11 is specified in advance as a specified position. The distance from end section E1 to the specified position in the main scanning direction is specified as the reference value of distance X1, and the distance from end section E3 to the specified position in the sub scanning direction is specified as the reference value of distance Y1. The reference values are specified in the same manner for other images for detection M12 to M14 and M21 to M24.

(Step S16)

When the calculated distances (e.g., X1, X2, Y1, and Y2) are within the predetermined ranges of the reference values, control section 200 notifies a user that image position is normal and terminates the image alignment. Control section 200 notifies the user that the image position is normal with voice or screen display using a speaker or a display section included in image forming apparatus 1, for example.

(Step S17)

When the calculated distances (e.g., X1, X2, Y1, and Y2) are not within the predetermined ranges of the reference values, control section 200 calculates differences (amounts of misalignment) between the calculated distances and the reference values.

(Step S18)

Control section 200 changes the positions where images for detection M11 to M14 and M21 to M24 are formed by changing image forming conditions related to image forming positions in image forming section 20 based on the calculated differences, and the processing returns to step S11. That is, control section 200 repeats the formation of the images for detection, the detection, and the position change until the calculated distances (e.g., X1, X2, Y1, and Y2) are within the predetermined ranges of the reference values. The image forming conditions related to image forming positions include, for example, start timings of image formation in the main scanning direction and the sub scanning direction. The image forming positions are changed by changing the start timings of image formation.

The above steps S15, S17 and S18 will be described below. The reference value of distance X1 is referred to as X01. Likewise, the reference value of distance X2 is referred to as X02, the reference value of distance Y1 is referred to as Y01, and the reference value of distance Y2 is referred to as Y02.

The image alignment in the main scanning direction on the image for detection M11 side of sheet S (the upper left side of FIG. 3B), for example, includes calculating distance X1 from end section E1 of sheet S to image for detection M11 on sheet S, and determining whether distance X1 is within a predetermined range of reference value X01. When distance X1 is out of the predetermined range of reference value X01, a difference between distance X1 and reference value X01 is calculated, and the image forming condition is changed so that distance X1 is within the predetermined range of reference value X01, thereby changing the image forming position.

Likewise, the image alignment in the main scanning direction on the image for detection M12 side of sheet S (the upper right side of FIG. 3B) includes calculating distance X2 from end section E1 of sheet S to image for detection M12 on sheet S, and determining whether distance X2 is within a predetermined range of reference value X02. When distance X2 is out of the predetermined range of reference value X02, a difference between distance X2 and reference value X02 is calculated, and the image forming condition is changed so that distance X2 is within the predetermined range of reference value X02, thereby changing the image forming position.

The image alignment in the main scanning direction on the image for detection M13 side of sheet S (the lower left side of FIG. 3B) and on the image for detection M14 side of sheet S (the lower right side of FIG. 3B) is performed in the similar way to that for images for detection M11 and M12. As described above, the image alignment in the main scanning direction is performed with end section E1 of sheet S as a reference.

Further, the image alignment in sheet conveyance direction D on the image for detection M11 side of sheet S (the upper left side of FIG. 3B) includes calculating distance Y1 from end section E3 of sheet S to image for detection M11 on sheet S, and determining whether distance Y1 is within a predetermined range of reference value Y01. When distance Y1 is out of the predetermined range of reference value Y01, a difference between distance Y1 and reference value Y01 is calculated, and the image forming condition is changed so that distance Y1 is within the predetermined range of reference value Y01, thereby changing the image forming position.

Likewise, the image alignment in sheet conveyance direction D on the image for detection M12 side of sheet S (the upper right side of FIG. 3B) includes calculating distance Y2 from end section E3 of sheet S to image for detection M12 on sheet S, and determining whether distance Y2 is within a predetermined range of reference value Y02. When distance Y2 is out of the predetermined range of reference value Y02, a difference between distance Y2 and reference value Y02 is calculated, and the image forming condition is changed so that distance Y2 is within the predetermined range of reference value Y02, thereby changing the image forming position.

The image alignment in sheet conveyance direction D on the image for detection M13 side of sheet S (the lower left side of FIG. 3B) and on the image for detection M14 side of sheet S (the lower right side of FIG. 3B) is performed in the similar way to that for images for detection M11 and M12. Note that the image alignment on the images for detection M13 and M14 may be performed with end section E4 as a reference, as described above.

Although the above description is for the image alignment for images for detection M11 to M14 formed on the front surface of sheet S, the similar image alignment can be applied to images for detection M21 to M24 formed on the back surface of sheet S. This enables image alignment on the back surface as well as on the front surface of sheet S.

The image forming positions are changed based on the positions (detection results) of images for detection M11 to M14 formed on the front surface of sheet S as described above. This corrects misalignment in the main scanning direction, the sub scanning direction, and the rotation direction, and also corrects magnification in the main scanning direction and the sub scanning direction, for an image to be formed on the front surface of sheet S. Likewise, the image forming positions are changed based on the positions (detection results) of images for detection M21 to M24 formed on the back surface of sheet S. This corrects misalignment in the main scanning direction, the sub scanning direction, and the rotation direction, and also corrects magnification in the main scanning direction and the sub scanning direction, for an image to be formed on the back surface of sheet S.

The above-described image alignment may be performed in adjusting image forming apparatus 1 (when image forming apparatus 1 is not printing), or may be performed for each sheet in printing. In this case, a printing image is formed on sheet S as well as images for detection M11 to M14 and M21 to M24 in above step S12. In addition, the image forming position of the printing image is changed as well as those of images for detection M11 to M14 and M21 to M24 in above step S18. The image forming positions are changed for each sheet as described above, and this improves the accuracy of correcting misalignment in the main scanning direction, the sub scanning direction, and the rotation direction, and correcting magnification in the main scanning direction and the sub scanning direction. This also makes real-time correction possible.

As described above, in image forming apparatus 1 of the present embodiment, image reading section 500 includes detection sections 501 and 502 that detect positions of a plurality of images for detection formed in different positions in a main scanning direction of a sheet by image forming apparatus body 100. Detection sections 501 and 502 have a detection range equal to or shorter than the width of the sheet in the main scanning direction.

Image forming apparatus 1 with such a configuration according to the present embodiment enables detection sections 501 and 502 to have a shorter width in the main scanning direction, thereby reducing the apparatus cost. Image alignment can be performed using detection sections 501 and 502 with shorter width in the main scanning direction.

In the embodiment described above, control section 200 functions as a calculation section that calculates distances between end sections E1 and E3 of sheet S and images for detection M11 to M14 and M21 to M24 on sheet S, and also calculates differences between the distances and reference values, but the calculation section may be provided in image reading section 500. In this case, control section 200 changes image forming positions based on the differences calculated in image reading section 500.

Detection sections 501 and 502 need not detect the entire surface of sheet S in the embodiment described above, and may only detect parts where images for detection M11 to M14 and M21 to M24 are formed.

Although image reading section 500 includes detection sections 501 and 502 in the embodiment described above, image reading section 500 may be configured with either one of detection sections 501 and 502. In a case of a configuration with detection section 501, for example, images for detection M11 to M14 are formed on the front surface of sheet S. In a case of a configuration with detection section 502, images for detection M21 to M24 are formed on the back surface of sheet S.

In the embodiment described above, image reading section 500 is configured as an independent device from image forming apparatus body 100, but image reading section 500 may be incorporated in image forming apparatus body 100 and placed between fixing section 30 and sheet ejection conveyance section 43.

Image forming apparatus 1 may include an automatic document feeding device called an auto document feeder (ADF) and a document image scanning device called a scanner, although image forming apparatus 1 in the above-described embodiment is not configured with such devices. In this case, the automatic document feeding device automatically and consecutively conveys a plurality of documents to the document image scanning device, and the document image scanning device consecutively reads images (including both sides) of the conveyed documents. Input image data is generated accordingly and is inputted to image processing section 10.

In addition, any of the embodiment described above merely illustrates one example of embodiment for carrying out the present invention, and the technical scope of the present invention shall not be construed in a limited manner thereby. That is, the present invention can be carried out in various forms without deviating from the gist or essential characteristics of the present invention.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image reading apparatus, comprising:
a detector that detects positions of a plurality of images for detection formed in different positions in a main scanning direction of a recording medium by an image forming apparatus, wherein the detector has a detection range equal to or shorter than a width of the recording medium in the main scanning direction.

2. The image reading apparatus according to claim 1, wherein the detection range is equal to or shorter than the width of the recording medium that is largest possible among a plurality of the recording mediums available for the image forming apparatus.

3. The image reading apparatus according to claim 1, wherein the detector is placed striding across one end of the recording medium in the main scanning direction.

4. The image reading apparatus according to claim 3, further comprising a hardware processor that calculates a distance between the one end and each of the plurality of images for detection in the main scanning direction.

5. The image reading apparatus according to claim 4, wherein the hardware processor calculates a distance between another end of the recording medium and each of the plurality of images for detection in a sub scanning direction.

6. The image reading apparatus according to claim 4, wherein the hardware processor calculates, based on the calculated distance, an amount of misalignment from a pre-specified position of each of the plurality of images for detection.

7. The image reading apparatus according to claim 1, wherein the plurality of images for detection are formed at three points or more on at least one of a front surface and a back surface of the recording medium so as to be in different positions in at least one of the main scanning direction and a sub scanning direction.

8. The image reading apparatus according to claim 1, wherein the detector comprises:
a first detector that detects the positions of the plurality of images for detection formed on a front surface of the recording medium; and
a second detector that detects the positions of the plurality of images for detection formed on a back surface of the recording medium.

9. An image forming apparatus, comprising:
an image former that forms an image on a recording medium; and
the image reading apparatus according to claim 1, wherein the image reading apparatus performs detection for the positions of the plurality of images for detection formed on the recording medium by the image former.

10. The image forming apparatus according to claim 9, wherein the image former changes a position of the image to be formed on the recording medium based on a result of the detection for the positions of the plurality of images for detection by the image reading apparatus.

11. The image forming apparatus according to claim 10, wherein
the image reading apparatus performs the detection, for each of a plurality of the recording mediums, for the positions of the plurality of images for detection, and
the image former changes, for each of the plurality of recording mediums, the position of the image to be formed based on a result of the detection.
